(19) United States
(12) Patent Application Publication
(10) Pub. No.: US 2026/0131525 A1
(43) Pub. Date: May 14, 2026

(54) Film Application Apparatus

(71) Applicant: Electronic Silk Road (Shenzhen) Tech Co., Ltd., Shenzhen (CN)

(72) Inventor: Xueliang Chen, Shenzhen (CN)

(21) Appl. No.: 19/242,881

(22) Filed: Jun. 18, 2025

(30) Foreign Application Priority Data
Nov. 11, 2024 (CN) 202422743373.X

(51) Int. Cl. B29C 63/02; B29L 31/34

(52) U.S. Cl. CPC B29C 63/02; B29L 2031/3437

(57) ABSTRACT

The present application provides a film application apparatus. A limiting member for limiting a transverse and longitudinal movement of a mobile phone along a bottom plate is disposed on an upper end surface of the bottom plate, a first side of the limiting member is provided with a first avoidance hole for allowing a first release paper to pass, a second side of the limiting member is provided with a second avoidance hole for allowing a positioning lug to pass, a positioning column is disposed on the upper end surface of the bottom plate and is located on the second side of the limiting member, and the positioning column is used for cooperation with a positioning hole of a second release paper. By means of the above-mentioned disclosed film application apparatus, air bubbles generated between the protective film and the screen of the mobile phone are effectively reduced.

### CROSS REFERENCES TO RELATED APPLICATION

The present application claims the benefit of Chinese Patent Application No. 202422743373.X filed on Nov. 11, 2024, the contents of which are incorporated herein by reference in their entirety.

### TECHNICAL FIELD

The present application relates to the field of film application for mobile phones, in particular to a film application apparatus.

### BACKGROUND ART

At present, a mobile phone has become one of the most important communication tools used by people. In a use process of the mobile phone, it is easy to scratch a screen thereof to form a scratch, which affects the display effect and beauty of the screen of the mobile phone. Therefore, in order to protect the screen from being scratched, most of users will apply a film to the screen of the mobile phone for protection.

However, when an operation of film application to the mobile phone is performed, it is difficult to accurately position a protective film of the mobile phone and the screen of the mobile phone. Therefore, during film application to the mobile phone, it needs to take a lot of time to slowly calibrate the protective film of the mobile phone and the screen of the mobile phone, which causes operation trouble and time waste.

### SUMMARY OF THE INVENTION

To this end, embodiments of the present application provide a film application apparatus to solve the problems of operation trouble and time waste brought by a requirement for lots of time taken for slowly calibrating a protective film of a mobile phone and a screen of the mobile phone during film application to the mobile phone.

In order to achieve the above-mentioned objects, embodiments of the present application provide the following technical solutions:
a film application apparatus includes a bottom plate, a positioning column and a limiting member;
the limiting member is disposed on an upper end surface of the bottom plate and is used for limiting the transverse and longitudinal movement of a mobile phone along the bottom plate, a first side of the limiting member is provided with a first avoidance hole for allowing a first release paper to pass, and a second side of the limiting member is provided with a second avoidance hole for allowing a positioning lug to pass; and
the positioning column is disposed on the upper end surface of the bottom plate and is located on the second side of the limiting member, and the positioning column is used for cooperation with a positioning hole of the second release paper.

Further, the limiting member includes a first limiting assembly and a second limiting assembly;
a fixed position for limiting the transverse and longitudinal movement of the mobile phone along the bottom plate is enclosed by the first limiting assembly and the second limiting assembly; and
the first limiting assembly is provided with the first avoidance hole, and the second limiting assembly is provided with the second avoidance hole.

Further, the first limiting assembly is the same as the second limiting assembly and includes a first limiting member and a second limiting member; and each of the first limiting member and the second limiting member is an L-shaped structural member.

Further, the film application apparatus further includes a plurality of bosses and an elastic supporting member; the plurality of bosses being disposed on the upper end surface of the bottom plate and being disposed along an edge of the fixed position, and the plurality of bosses being used for supporting a terminal device; and the elastic supporting member being disposed on the upper end surface of the bottom plate and being located in the fixed position, an upper end surface of the elastic supporting member being higher than upper end surfaces of the bosses, and the elastic supporting member being used for supporting the film assembly.

Further, the elastic supporting member is of an elongated structure; and the elastic supporting member is disposed on the bottom plate along a drawing direction of the drawing strip.

Further, the film application apparatus further includes a pressing plate and a third limiting assembly; a contact surface, in contact with the back of the mobile phone, of the pressing plate being provided with a plurality of first protruded members, wherein the plurality of first protruded members are distributed on a first side and a second side of the pressing plate; the first limiting assembly and the third limiting assembly being disposed on a first side of the bottom plate, the second limiting assembly being disposed on a second side of the bottom plate, and the first limiting assembly being located between the second limiting assembly and the third limiting assembly; and the third limiting assembly and the second limiting assembly being used for cooperation with the plurality of first protruded members to limit the transverse and/or longitudinal movement of the pressing plate.

Further, the third limiting assembly includes a third limiting member and a fourth limiting member; and each of the third limiting member and the fourth limiting member is an L-shaped structural member.

Further, the film application apparatus further includes a second protruded member disposed in the middle of the pressing plate; and
the second protruded member being of an annular structure.

Further, the film application apparatus further includes a flexible connecting piece for connecting the pressing plate and the bottom plate.

Further, the positioning column and the first avoidance hole are oppositely disposed on two sides of the fixed position.

Further, the pressing plate is provided with a through hole, and the through hole is adapted to a camera component disposed on the back of the mobile phone so that the camera component is exposed via the through hole when the pressing plate covers the back of the mobile phone.

Based on the above-mentioned film application apparatus provided by the present application, the limiting member for limiting the transverse and longitudinal movement of the mobile phone along the bottom plate is disposed on the upper end surface of the bottom plate, the first side of the limiting member is provided with the first avoidance hole for allowing the first release paper to pass, the second side of the limiting member is provided with the second avoidance hole for allowing the positioning lug to pass, the positioning column is disposed on the upper end surface of the bottom plate and is located on the second side of the limiting member, and the positioning column is used for cooperation with the positioning hole of the second release paper. By means of the above-mentioned disclosed film application apparatus, the mobile phone can be fixed by the limiting member, the protective film can be positioned by the positioning column, and then, after the drawing strip is drawn out, the protective film can be accurately attached to the screen of the mobile phone, and the mobile phone is pressed during film application, so that the protective film is gradually attached to the screen of the mobile phone under the action of a pressing force, which effectively reduces air bubbles generated between the protective film and the screen of the mobile phone.

### BRIEF DESCRIPTION OF THE DRAWINGS

In order to describe the technical solutions in the embodiments of the present application or the prior art more clearly, the accompanying drawings required for describing the embodiments or the prior art will be briefly introduced below. Apparently, the accompanying drawings in the following description show only some embodiments of the present application, and those of ordinary skill in the art may still derive other accompanying drawings from these accompanying drawings without creative efforts.

FIG. 1 is an exploded view of a film application apparatus provided in an embodiment of the present application;

FIG. 2 is a schematic structural diagram of a film assembly provided in an embodiment of the present application;

FIG. 3 is a schematic diagram of an overall placement position shown when a film is applied to a mobile phone provided in an embodiment of the present application;

FIG. 4 is a top view shown when a mobile phone is placed on a film application apparatus provided in an embodiment of the present application;

FIG. 5 is a view of the back of a film application apparatus provided in an embodiment of the present application; and

FIG. 6 is a schematic diagram of a use state of a film application apparatus provided in another embodiment of the present application.

In which, bottom plate 1, mounting slot 1-1, elastic supporting member 2, positioning column 3, first limiting assembly 4, first limiting member 41, second limiting member 42, second limiting assembly 5, boss 6, first avoidance hole 7, second avoidance hole 8, pressing plate 91, first protruded member 92, second protruded member 93, third limiting assembly 10, flexible connecting piece 11, anti-skid mat 12, mobile phone 13, film assembly 14; and
film assembly 14: drawing strip 141, and second release paper 142.

### DETAILED DESCRIPTION OF THE INVENTION

The technical solutions in the embodiments of the present application will be described clearly and completely below in conjunction with the accompanying drawings in the embodiments of the present application. Apparently, the described embodiments are only a part of the embodiments of the present application, not all the embodiments. Based on the embodiments in the present application, all other embodiments obtained by those of ordinary skill in the art without creative work shall fall within the protection scope of the present application.

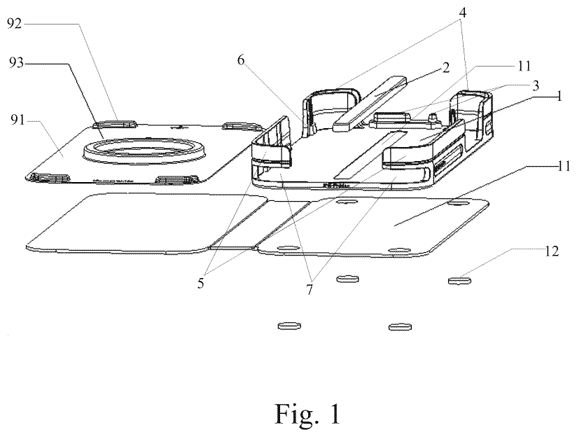

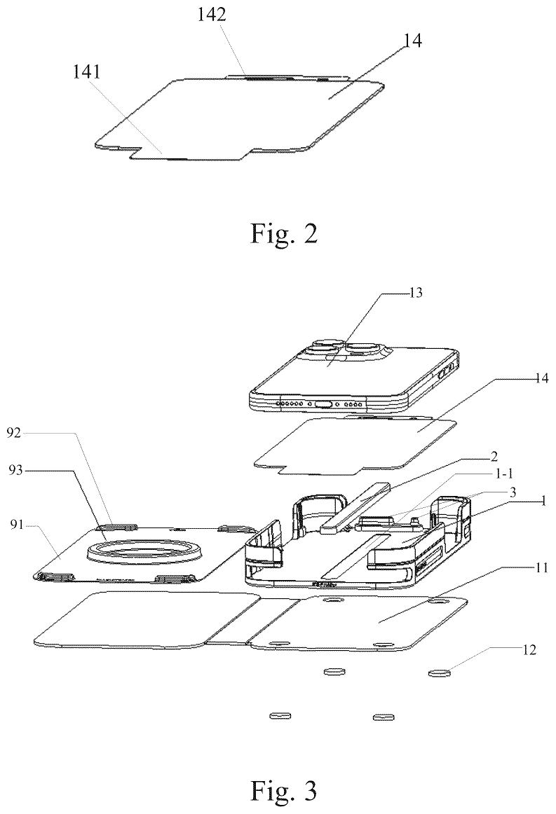

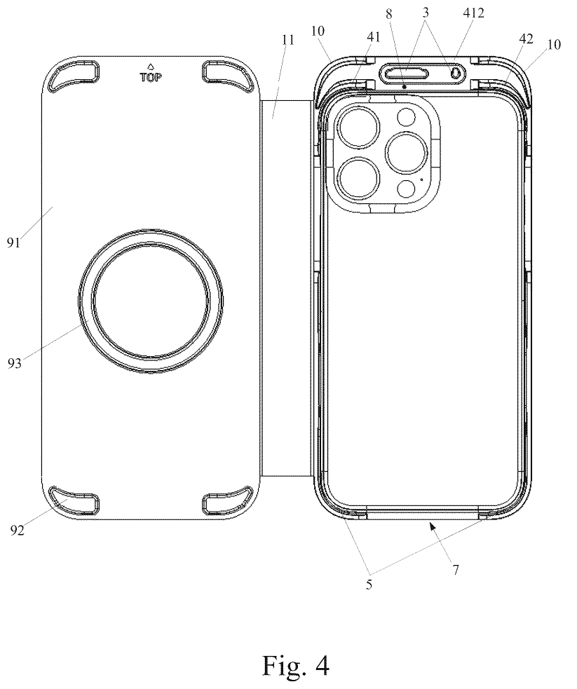

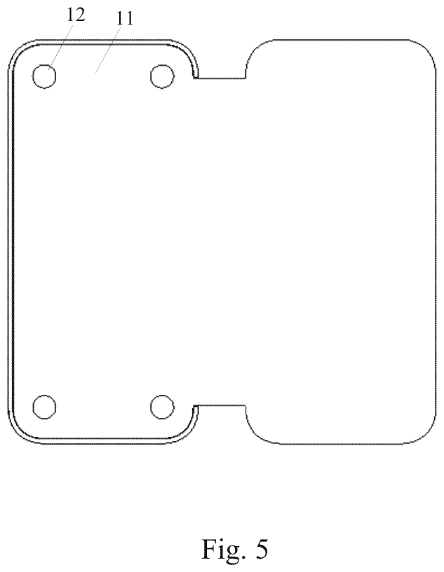

An embodiment of the present application provides a film application apparatus, referring to FIG. 1 through FIG. 5, FIG. 1 is a schematic structural diagram of a film application apparatus, and the film application apparatus includes a bottom plate 1, a positioning column 3 and a limiting member;
the limiting member is disposed on an upper end surface of the bottom plate 1 and is used for limiting the transverse and longitudinal movement of a mobile phone 13 along the bottom plate 1;
a first side of the limiting member is provided with a first avoidance hole 7 for allowing a first release paper to pass, and a second side of the limiting member is provided with a second avoidance hole 8 for allowing a positioning lug to pass; and
the positioning column 3 is disposed on the upper end surface of the bottom plate 1 and is located on the second side of the limiting member, and the positioning column 3 is used for cooperation with a positioning hole of a second release paper 142.

It should be noted that the film application apparatus in the present application can be used for film application to a terminal device with a screen, such as the mobile phone 13, and therefore, embodiments of the present application are all illustrated with the mobile phone 13 as an example. The film application apparatus in the present application is mainly used for construction for a film assembly 14 composed of a drawing strip 141, a protective film, a first release paper and a second release paper 142, wherein the first release paper is pasted on an upper end surface of the protective film, the second release paper 142 is pasted on a lower end surface of the protective film, a first side of the second release paper 142 is provided with a positioning lug protruding out of a first side of the protective film, the positioning lug is provided with a positioning hole, the drawing strip 141 is disposed on an upper end surface of the first release paper, one side of the drawing strip 141 is connected with one side of the first release paper, and a drawing end of the drawing strip 141 protrudes out of a second side of the protective film. When film application to the mobile phone 13 is needed, the mobile phone 13 is placed on the bottom plate 1, and the screen of the mobile phone 13 is aligned to the drawing strip 141; then, the back of the mobile phone 13 is pressed, and the first release paper is stripped from a pasted surface of the protective film via the drawing end of the drawing strip 141 and is drawn out of the first avoidance hole 7, at the time, the protective film is attached to the screen of the mobile phone 13 under the action of a pressing force; and since the first release paper is gradually stripped from one side of the protective film, the protective film is also gradually attached to the screen of the mobile phone 13, and air bubbles generated between the protective film and the screen of the mobile phone 13 is avoided under the action of the pressing force.

It should be further noted that when the drawing strip 141 is drawn out of the first avoidance hole 7, dust on the screen of the mobile phone 13 can be removed by the drawing strip 141 and the first release paper, which ensures that the protective film is better attached to the screen of the mobile phone 13, and influences of the dust on screen viewing experience of users are avoided.

It should be especially noted that the present application is not only applicable to film application to the mobile phone 13, but also is applicable to film application to other terminal devices with screens.

In the embodiment of the present application, the limiting member for limiting the transverse and longitudinal movement of the mobile phone 13 along the bottom plate 1 is disposed on the upper end surface of the bottom plate 1, the first side of the limiting member is provided with the first avoidance hole 7 for allowing the first release paper to pass, the second side of the limiting member is provided with the second avoidance hole 8 for allowing the positioning lug to pass, the positioning column 3 is disposed on the upper end surface of the bottom plate 1 and is located on the second side of the limiting member, and the positioning column 3 is used for cooperation with the positioning hole of the second release paper 142. By means of the above-mentioned disclosed film application apparatus, the mobile phone 13 can be fixed by the limiting member, the protective film can be positioned by the positioning column 3, and then, after the drawing strip 141 is drawn out, the protective film can be accurately attached to the screen of the mobile phone 13, and the mobile phone 13 is pressed during film application, so that the protective film is gradually attached to the screen of the mobile phone 13 under the action of a pressing force, which effectively reduces air bubbles generated between the protective film and the screen of the mobile phone 13.

Specifically, the limiting member includes a first limiting assembly 4 and a second limiting assembly 5;
a fixed position for limiting the transverse and longitudinal movement of the mobile phone 13 along the bottom plate 1 is enclosed by the first limiting assembly 4 and the second limiting assembly 5; and
the first limiting assembly 4 is provided with the first avoidance hole 7, and the second limiting assembly 5 is provided with the second avoidance hole 8.

It should be noted that the limiting member can be the fixed position enclosed by the first limiting assembly 4 and the second limiting assembly 5 and used for limiting the transverse and longitudinal movement of the mobile phone 13 along the bottom plate 1, and can also be of an integral frame structure, which can be selected as required by the skilled in the art.

Specifically, the first limiting assembly 4 is the same as the second limiting assembly 5 and includes a first limiting member 41 and a second limiting member 42; and
each of the first limiting member 41 and the second limiting member 42 is an L-shaped structural member.

It should be noted that the first limiting assembly 4 is set to be the same as the second limiting assembly 5 and is set as the L-shaped first limiting member 41 and second limiting member 42, and then, the first limiting assembly 4 and the second limiting assembly 5 cooperate with each other to enclose the fixed position for limiting the transverse and longitudinal movement of the mobile phone 13 along the bottom plate 1.

It should be further noted that the second avoidance hole 8 for allowing the positioning lug to pass can be formed between the first limiting member 41 and the second limiting member 42 of the first limiting assembly 4.

It is noteworthy that the second limiting assembly 5 can be set as two L-shaped limiting member structures which are the same as those of the first limiting assembly 4, and can also be set as an integral U-shaped limiting member, and the bottom thereof is provided with the first avoidance hole 7, which can also limit the transverse and longitudinal movement of the mobile phone 13 and allow the first release paper to pass.

Further, the film application apparatus further includes a plurality of bosses 6 and an elastic supporting member 2;
the plurality of bosses 6 are disposed on the upper end surface of the bottom plate 1 and are disposed along an edge of the fixed position, and the plurality of bosses 6 are used for supporting a terminal device; and
the elastic supporting member 2 is disposed on the upper end surface of the bottom plate 1 and is located in the fixed position, an upper end surface of the elastic supporting member 2 is higher than upper end surfaces of the bosses 6, and the elastic supporting member 2 is used for supporting the film assembly 14.

It should be noted that the plurality of bosses 6 are disposed on the upper end surface of the bottom plate 1 and are disposed along the edge of the fixed position, and the plurality of bosses 6 are used for supporting a terminal device, the elastic supporting member 2 is disposed on the upper end surface of the bottom plate 1 and is located in the fixed position, the upper end surface of the elastic supporting member 2 is higher than upper end surfaces of the bosses 6, and the elastic supporting member 2 is used for supporting the film assembly 14. Then, when film application to the mobile phone 13 is needed, the mobile phone 13 is placed in the fixed position, and the screen of the mobile phone 13 is aligned to the drawing strip 141; then, the back of the mobile phone 13 is pressed, and the first release paper is stripped from a pasted surface of the protective film via the drawing end of the drawing strip 141 and is drawn out of the first avoidance hole 7, at the time, the protective film can be in contact with the screen of the mobile phone 13 all the time under the action of an elastic restoring force provided by the elastic supporting member 2, which effectively reduces air bubbles generated between the screen of the mobile phone 13 and the protective film; and the drawing strip 41 is gradually drawn to be removed, the elastic restoring force provided by the elastic supporting member 2 is constant, and therefore, air bubbles generated between the protective film and the screen of the mobile phone 13 can be effectively reduced.

It should be further noted that the first release paper is stripped from the pasted surface of the protective film via the drawing end of the drawing strip 141 and is drawn out of the first avoidance hole 7, at the time, the middle of the protective film is in contact with the screen of the mobile phone 13 firstly under the action of the elastic restoring force provided by the elastic supporting member 2, and then gradually spreads all around under the elastic restoring force provided by the elastic supporting member 2 so as to be in contact with and attached to the screen of the mobile phone 13 and exhaust air all around, which avoids influences of the air bubbles generated between the protective film and the screen on the viewing experience of users.

Specifically, the elastic supporting member 2 is of an elongated structure; and
the elastic supporting member 2 is disposed on the bottom plate 1 along a drawing direction of the drawing strip 141.

It should be noted that the elastic supporting member 2 can be of the elongated structure or a structure of other shapes, which can be selected as required by the skilled in the art.

It is noteworthy that the elastic supporting member 2 can be disposed on the bottom plate 1 along the drawing direction of the drawing strip 141 or disposed along other directions on the bottom, which can be selected as required by the skilled in the art. However, in the present application, preferably, the elastic supporting member 2 is disposed on the bottom plate 1 along the drawing direction of the drawing strip 141.

Preferably, the bottom plate 1 is provided with a mounting slot 1-1 for mounting the elastic supporting member 2.

It should be noted that by providing the mounting slot 1-1 for mounting the elastic supporting member 2 in the bottom plate 1, the displacement of the elastic supporting member 2 in a process of film application due to pressing the mobile phone 13 can be avoided, and then, the smooth process of pasting the protective film is guaranteed.

Further, the film application apparatus further includes a pressing plate 91 and a third limiting assembly 10;
a contact surface, in contact with the back of the mobile phone 13, of the pressing plate 91 is provided with a plurality of first protruded members 92, wherein the plurality of first protruded members 92 are distributed on a first side and a second side of the pressing plate 91;
the first limiting assembly 4 and the third limiting assembly 10 are disposed on a first side of the bottom plate 1, the second limiting assembly 5 is disposed on a second side of the bottom plate 1, and the first limiting assembly 4 is located between the second limiting assembly 5 and the third limiting assembly 10; and
the third limiting assembly 10 and the second limiting assembly 5 are used for cooperation with the plurality of first protruded members 92 to limit the transverse and/or longitudinal movement of the pressing plate 91.

It should be noted that the pressing plate 91 and the third limiting assembly 10 are disposed, the contact surface, in contact with the back of the mobile phone 13, of the pressing plate 91 is provided with the plurality of first protruded members 92, and the plurality of first protruded members 92 are distributed on the first side and the second side of the pressing plate 91; the first limiting assembly 4 and the third limiting assembly 10 are disposed on the first side of the bottom plate 1, the second limiting assembly 5 is disposed on the second side of the bottom plate 1, and the first limiting assembly 4 is located between the second limiting assembly 5 and the third limiting assembly 10; the third limiting assembly 10 and the second limiting assembly 5 are used for cooperation with the plurality of first protruded members 92 to limit the transverse and/or longitudinal movement of the pressing plate 91; and then, when the back of the mobile phone 13 is pressed by the pressing plate 91 in the process of film application to the mobile phone 13, a force acting on the back of the mobile phone 13 can be more uniform, and the transverse and/or longitudinal movement of the pressing plate 91 can be avoided when the third limiting assembly 10 and the second limiting assembly 5 are used for cooperation with the plurality of first protruded members 92.

It is noteworthy that when the third limiting assembly 10 and the second limiting assembly 5 are used for cooperation with the plurality of first protruded members 92, the film application apparatus cannot deform in a process of transportation.

Specifically, the third limiting assembly 10 includes a third limiting member and a fourth limiting member; and
each of the third limiting member and the fourth limiting member is an L-shaped structural member.

It should be noted that the third limiting assembly 10 is set as the third limiting member and the fourth limiting member, each of the third limiting member and the fourth limiting member is the L-shaped structural member, and then, the third limiting assembly 10 and the second limiting assembly 5 cooperate with each other to enclose the fixed position for limiting the transverse and longitudinal movement of the mobile phone 13 along the bottom plate 1.

It is noteworthy that the third limiting assembly 10 can be set as the third limiting member and the fourth limiting member with each being the L-shaped structural member, and can also be set as an integral U-shaped limiting member.

Preferably, the positioning column 3 is located between the first limiting assembly 4 and the third limiting assembly 10.

Further, the film application apparatus further includes a second protruded member 93 disposed in the middle of the pressing plate 91; and
the second protruded member 93 is of an annular structure.

It should be noted that by disposing the second protruded member 93 in the middle of the pressing plate 91, after the drawing strip 141 drives the first release paper to separate from the protective film, the second protruded member 93 is pressed to enable the protective film to be in contact with the middle of the screen of the mobile phone 13 firstly and then gradually spread all around along a first contact position so that the protective film is gradually in contact with the screen and exhausts air all around, which avoids influences of air bubbles generated between the protective film and the screen on the viewing experience of users.

It should be further noted that the second protruded member 93 can be of the annular structure, and can also be of a structure of other shapes, which can be selected as required by the skilled in the art.

Further, the film application apparatus further includes a flexible connecting piece 11 for connecting the pressing plate 91 and the bottom plate 1.

It should be noted that by disposing the flexible connecting piece 11 for connecting the pressing plate 91 and the bottom plate 1, it is convenient for a user to press the mobile phone 13 by using the pressing plate 91 in the process of film application.

Preferably, the flexible connecting piece 11 is made of a paper board.

It should be noted that the flexible connecting piece 11 can be made of the paper board, and can also be made of other materials, which can be selected as required by the skilled in the art.

It is noteworthy that when the flexible connecting piece 11 is made of the paper board, one side of the paper board is pasted on the lower end surface of the bottom plate 1, and the other side thereof is pasted on a pressing surface of the pressing plate 91.

Specifically, the positioning column 3 and the first avoidance hole 7 are oppositely disposed on two sides of the fixed position.

It should be noted that the positioning column 3 and the first avoidance hole 7 are oppositely disposed on two sides of the fixed position, and can also be disposed on two adjacent sides of the fixed position, which can be selected as required by the skilled in the art.

Preferably, the elastic supporting member 2 is made of polyurethane foam.

It should be noted that the elastic supporting member 2 can be made of the polyurethane foam, and can also be made of other elastic materials capable of generating elastic deformation under the action of an external force, which can be selected as required by the skilled in the art.

Preferably, the film application apparatus further includes a plurality of anti-skid mats 12 disposed on the lower end surface of the bottom plate 1.

It should be noted that by disposing the plurality of anti-skid mats 12 on the lower end surface of the bottom plate 1, a friction force between a protective mat and an operating platform is increased, and then, when the drawing strip 141 is drawn, the slip of the bottom plate 1 relative to the operating platform is avoided.

Preferably, a third side of the limiting member is provided with a third avoidance hole for avoiding side buttons of the mobile phone 13.

It should be noted that parts of the side buttons of the mobile phone 13 are protruded, and in order to avoid the passing ability of the side buttons of the mobile phone 13 when the mobile phone 13 is placed in the limiting member, in the present application, the third side of the limiting member is provided with the third avoidance hole for avoiding the side buttons of the mobile phone 13, which effectively avoids influences of the side buttons of the mobile phone 13 on the entering of the mobile phone 13 into the limiting member.

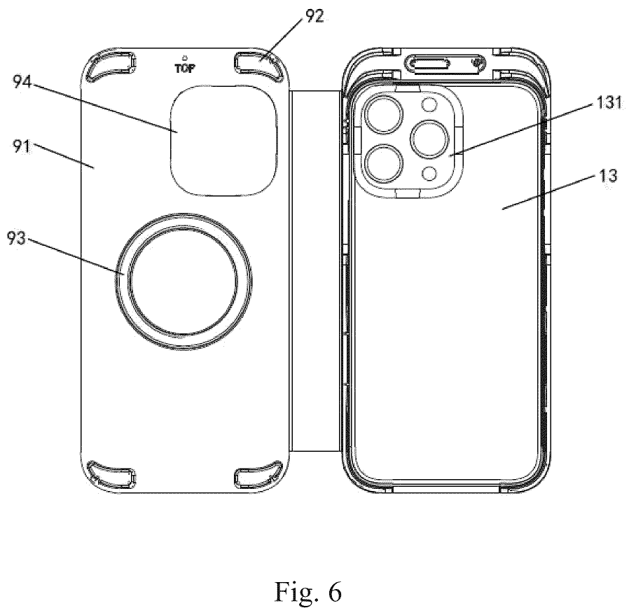

FIG. 6 shows another embodiment of the present application. As shown in FIG. 6, the film application apparatus in the present embodiment only differs from the film application apparatus in the aforesaid embodiment in that the pressing plate 91 is provided with a through hole 94, and the through hole 94 is adapted to a camera component 131 disposed on the back of the mobile phone 13.

Specifically, the through hole 94 is disposed in a first side (i.e., an upper side shown in the drawing) close to the pressing plate 91 and corresponds to the position of the camera component 131; and the through hole 94 is a rectangular hole with round corners and has a contour with the same shape as the camera component 131. When the pressing plate 91 covers the back of the mobile phone 13, the through hole 94 is aligned to the camera component 131 of the mobile phone 13 so that the camera component 131 is exposed via the through hole 94.

Based on above design of the through hole 94, when the back of the mobile phone 13 is pressed by using the pressing plate 91 in the process of film application to the mobile phone 13 by using the film application apparatus in the present embodiment, the camera component 131 can be successfully avoided, so that the force acting on the back of the mobile phone 13 is more uniform, and then, the probability that air bubbles are generated between the protective film and the screen of the mobile phone 13 can be reduced more effectively.

Due to the above-mentioned description for the disclosed embodiments, the skilled in the art may implement or use the present application. A plurality of amendments to these embodiments are apparent to the skilled in the art, and general principles defined in the present application may be achieved in the other embodiments without departing from the spirit or scope of the present application. Therefore, the present application will not be limited to these embodiments shown in the present application, but shall accord with the widest scope consistent with the principles and novel characteristics disclosed by the present application.

1. A film application apparatus applicable to a film assembly composed of a drawing strip, a protective film, a first release paper and a second release paper, wherein the first release paper is pasted on an upper end surface of the protective film, the second release paper is pasted on a lower end surface of the protective film, a first side of the second release paper is provided with a positioning lug protruding out of a first side of the protective film, the positioning lug is provided with a positioning hole, the drawing strip is disposed on an upper end surface of the first release paper, one side of the drawing strip is connected with one side of the first release paper, and a drawing end of the drawing strip protrudes out of a second side of the protective film, wherein the film application apparatus comprises a bottom plate, a positioning column and a limiting member;
the limiting member is disposed on an upper end surface of the bottom plate and is used for limiting a transverse and longitudinal movement of a mobile phone along the bottom plate, a first side of the limiting member is provided with a first avoidance hole for allowing the first release paper to pass, and a second side of the limiting member is provided with a second avoidance hole for allowing the positioning lug to pass; and
the positioning column is disposed on the upper end surface of the bottom plate and is located on the second side of the limiting member, and the positioning column is used for cooperation with the positioning hole of the second release paper.

2. The film application apparatus of claim 1, wherein the limiting member comprises a first limiting assembly and a second limiting assembly;
a fixed position for limiting the transverse and longitudinal movement of the mobile phone along the bottom plate is enclosed by the first limiting assembly and the second limiting assembly; and
the first limiting assembly is provided with the first avoidance hole, and the second limiting assembly is provided with the second avoidance hole.

3. The film application apparatus of claim 2, wherein the first limiting assembly is the same as the second limiting assembly and comprises a first limiting member and a second limiting member; and
each of the first limiting member and the second limiting member is an L-shaped structural member.

4. The film application apparatus of claim 2, further comprising a plurality of bosses and an elastic supporting member;
the plurality of bosses being disposed on the upper end surface of the bottom plate and being disposed along an edge of the fixed position, and the plurality of bosses being used for supporting a terminal device; and
the elastic supporting member being disposed on the upper end surface of the bottom plate and being located in the fixed position, an upper end surface of the elastic supporting member being higher than upper end surfaces of the bosses, and the elastic supporting member being used for supporting the film assembly.

5. The film application apparatus of claim 4, wherein the elastic supporting member is of an elongated structure; and
the elastic supporting member is disposed on the bottom plate along a drawing direction of the drawing strip.

6. The film application apparatus of claim 2, further comprising a pressing plate and a third limiting assembly;
a contact surface, in contact with the back of the mobile phone, of the pressing plate being provided with a plurality of first protruded members, wherein the plurality of first protruded members are distributed on a first side and a second side of the pressing plate;
the first limiting assembly and the third limiting assembly being disposed on a first side of the bottom plate, the second limiting assembly being disposed on a second side of the bottom plate, and the first limiting assembly being located between the second limiting assembly and the third limiting assembly; and
the third limiting assembly and the second limiting assembly being used for cooperation with the plurality of first protruded members to limit the transverse and/or longitudinal movement of the pressing plate.

7. The film application apparatus of claim 6, wherein the third limiting assembly comprises a third limiting member and a fourth limiting member; and
each of the third limiting member and the fourth limiting member is an L-shaped structural member.

8. The film application apparatus of claim 6, further comprising a second protruded member disposed in the middle of the pressing plate; and
the second protruded member being of an annular structure.

9. The film application apparatus of claim 6, further comprising a flexible connecting piece for connecting the pressing plate and the bottom plate.

10. The film application apparatus of claim 1, wherein the positioning column and the first avoidance hole are oppositely disposed on two sides of the fixed position.

11. The film application apparatus of claim 1, wherein the pressing plate is provided with a through hole, and the through hole is adapted to a camera component disposed on the back of the mobile phone so that the camera component is exposed via the through hole when the pressing plate covers the back of the mobile phone.
